(19) United States
(12) Patent Application Publication
(10) Pub. No.: US 2022/0033017 A1
(43) Pub. Date: Feb. 3, 2022

(54) CONTINUOUS TRACK DRIVE FOR VEHICLES

(71) Applicant: SPECIALIST VEHICLE RESEARCH AND DEVELOPMENT LTD., Badersfield, Norfolk (GB)

(72) Inventor: Tim DOCKERTY, Martham, Norfolk (GB)

(21) Appl. No.: 17/413,366

(22) PCT Filed: Dec. 12, 2019
(86) PCT No.: PCT/GB2019/053525

§ 371 Date: Jun. 11, 2021

(30) Foreign Application Priority Data
Dec. 14, 2018 (GB) 1820417.2

(51) Int. Cl. B62D 55/084; B62D 55/10; B62D 55/112; B62D 55/12; B62D 55/26; B62D 55/21; B62D 55/06

(52) U.S. Cl. CPC B62D 55/084; B62D 55/10; B62D 55/112; B62D 55/06; B62D 55/26; B62D 55/21; B62D 55/12

(57) ABSTRACT

A track drive cassette for a vehicle, comprising a drive motor adapted to power a drive sprocket, a continuous track having a portion adapted to engage with the drive sprocket, running wheels, and a return arrangement.

### FIELD OF THE INVENTION

The present inventive concept relates to a continuous track drive arrangement for vehicles. Especially, the present inventive concept relates to a modular cassette for a continuous track drive arrangement.

### BACKGROUND TO THE INVENTION

Continuous track drive arrangements, often referred to as “caterpillar” tracks after a nickname given to a trial device tested at the Aldershot Garrison in 1907, are used on vehicles that are designed to cross terrains that would challenge the capabilities of vehicles relying exclusively on wheels. Such conditions include:
Soft or boggy ground (in which a wheeled vehicle's wheels might otherwise sink or become bogged). This may include snow, mud, and other semi-liquid surfaces;
Rocky, rubble strewn ground, or ground otherwise containing ‘sharps’ that might otherwise puncture tyres or entangle wheels;
Friable surfaces such as sand, scree, gravel etc. and including areas where such aggregates are found strewn across many off-road gradients;
Pressure sensitive ground (such as in nature reserves or sites of special scientific interest (SSSI)) where the weight of a vehicle, if distributed only between smaller contact surfaces of discrete wheels, might compress and damage animal or plant life or soil or other structures.

Continuous tracks essentially place a resilient barrier (a vehicle's own portable road surface) between the ground and the vehicle's wheels that run over them enabling such vehicles to more readily cross terrains such as the aforementioned. A vehicle's tracks spread the weight of the vehicle across the entire surface area of the track that is in contact with the ground so reducing the vehicle's measured ground pressure in comparison to that otherwise presented only by its supporting wheels. Vehicles using tracks include military tanks, tractors, earth moving equipment etc.

Because tracks and the suspension systems used on vehicles using tracks need to be resilient to a variety of potentially damaging environments they tend to be made of materials that are dense and, therefore, heavy, making maintenance or repairs to tracks and tracked vehicle suspensions difficult and potentially dangerous—especially where such a maintenance need arises on unstable ground during in-field deployment. Innovations that can avoid or simplify any aspect of such work will be welcomed.

Similarly, anything that can extend the range of surfaces over which a tracked vehicle can operate—by definition also extends the number of areas it can access—and access is the sole key to the requirement for the use of any tracked vehicle. The ability to successfully traverse still softer ground would, for example, improve the likelihood of reaching survivors trapped by mudslide, or avalanche, whilst the ability to traverse ground containing still more severe sharps (perhaps twisted reinforcing bars from collapsed buildings) would make gaining access to survivors of earthquakes more likely. The ability to climb or cross still steeper slopes, or more severely obstacle strewn terrains, or still softer ground is, therefore, key.

Tracked vehicles divide broadly into two groups—those with sprung suspension and those without. Those with sprung suspension are generally intended to move at speed across various terrains. Here, suspension is required to cushion or smooth the impacts on the vehicle and its occupants by the changing vectors of momentum induced by the changing angles over which it travels and the differing support offered by the terrain. Boulders, ridges, ditches, soft and hard surfaces all impact differently on the vehicle which, without suspension, would become increasingly hard to control—or for passengers to even bear being inside, as its speed increases.

Vehicles without suspension tend to be slow moving yet offer great stability. Such vehicles include tractors (where their design is mostly about transferring as much power as possible to the ground to allow the vehicle to draw implements through the soil or crop, for example) and earth movers and excavators—where their lack of suspension (their stability) enables their grader or bucket, for example, to be placed with an accuracy that otherwise flexing suspension may not permit. Excavators also benefit from long tracks designed to spread the vehicle's weight as well as improving their longitudinal stability and which are placed widely apart to similarly maximise lateral stability when, for example, drawing their bucket from the side.

The tracks on tracked vehicles follow fixed paths: under the wheels; around the sprockets; back to the front of the vehicle via a series of return-rollers; and around and back to the wheels via a front idlerwheel or sprocket. To maintain the correct tension in the tracks the length of this described path must be maintained as only fractionally shorter than that of the track itself since this permits a limited sag in the returning (upper) sections of the track due to gravity. Since tracks are generally heavy, without this allowance for sag the tracks would be over-tensioned. The maximum extension of the suspension is restricted by the length of the track.

Side-slopes are a challenge for tracked vehicles, especially those with sprung suspension, as it is generally not possible to secure their tracks to the vehicle in a way which prevents the vehicle from ‘stepping out’ of them whilst traversing side-slopes.

Non-sprung tracked vehicles can manage side-slopes more readily—provided their track's tension is correctly adjusted since, because continuous tracks are generally designed not to stretch, considerable forces are needed to force a non-sprung track out of alignment with its wheels or sprockets before the vehicle can ‘step out’ of them. Tracks that have sprung suspension must (through the action of that suspension) compress and extend their suspension whilst in motion. Since tracks do not generally stretch, this mean that when a vehicle's suspension is compressed—the entire loop forming the complete track briefly loses tension (becomes slack) until some mechanism counters that issue. Most brochures for tracked vehicles list the angle of the side-slope across which the vehicle can be ‘safely’ traversed. Most operators, however, recognise the ease with which tracked-vehicles with sprung-suspension step out of (dismount or shed) their tracks and the industry wisdom is that for all but the gentlest of side-slopes tracked vehicles are best driven straight down (or up the slope) and then driven in as laterally flat a mode as possible along the valley floor or the top of the slope's ridge until the destination is reached. In some circumstances this may require a circuitous route to be driven—for example three sides of a square.

A track may be formed from a single one-piece band of a composite such as a reinforced rubber, or from a plurality of individual track-links (links). Both are termed a “continuous track”. Where links are used they are constructed such that a simple metal bar (a track-pin, or simply a ‘pin’) is pushed through the predrilled interlocking faces of a pair of links (just like the pin through a door hinge). This pin then holds them together whilst allowing each link a limited rotation around this pin. The process is repeated until the correct length of track is produced. The two ends of the track are then joined in the same manner to create the completed track. Spring washers are often fitted in a groove around the ends of these pins to prevent them sliding back out. This method describes the construction of a so called ‘dead’ track since all joined links will simply lay flat when placed on the ground. Alternatively, this same hole through the links may be filled with a bonded rubber sleeve which surrounds and centres an inner metal tube—often with a hexagonal cross-section through its centre.

When individual links are to be joined a track-pin with a similar hexagonal cross-section is pushed through these tubes joining the links (exactly as with the former method). The advantage of this second method is that the bonded rubber sleeve combined with the tighter tolerances of the track-pins inside the tube helps prevent granular particles (e.g. sand) wearing away the internal surfaces of the links and their pins during use. This method of construction creates a ‘live’ track since the pre-set angle the tube is held at by the rubber causes the track to try and roll up on itself when laid flat. Nevertheless, once the rubber in live-tracks is compromised through wear by sand, or sand has worn a dead track's pins and their corresponding drillings beyond an acceptable limit—both types of links become scrap. The former can't be successfully re-drilled, and removing the tube surrounded by the partially degraded bonded rubber in the latter makes drilling them out for reuse uneconomic. Track-link castings often have complex shapes making them expensive to produce and the extra processes in the manufacture of live tracks make them more expensive than dead ones. Costs are compounded when disposing of live-links since scrap-merchants are reluctant to process the rubber.

Each track link within a track usually carries a track-horn which is a vertical upstand rising (most usually) from the longitudinal centre-line of the link and shaped to pass with minimal clearance between the inside faces of the vehicle's paired and, back-to-back placed, supporting wheels. When a tracked-vehicle turns it induces lateral forces on its running wheels that try to slide them out of alignment with the links (track) beneath them. During turns the horns come into contact with the inside face of one or other paired wheels preventing the wheels from sliding off the track. The relationship between horn length and running wheel size is important. Short track-horns matched with large wheels would offer the potential for the wheels to ride sideways over the horns so potentially shedding the track. Large horns with small wheels is not possible since the horn would hit the converging inside faces of the wheels. A considered match is required. Tracked vehicles turn by creating a difference in speed between their tracks (which are usually placed on either side of the vehicle). This causes a controlled skid in both tracks causing the vehicle to turn towards the slower track. Some vehicles can undertake an extreme version of this by turning their tracks in opposite directions causing one side of the vehicle to move forwards whilst the other moves backwards causing the vehicle to revolve on the spot (a neutral turn). During a neutral turn the vehicle's centre of rotation is determined by its point of longitudinal balance.

Whether a vehicle is expected to be driven on manufactured surfaces (tarmac, concrete etc.) determines whether its links (where hard and otherwise damaging) will be required to carry surface-protecting track-pads. If yes, these pads, often manufactured from a rubber compound, are mounted on the bottom of each link such that when in use they are placed between the link and the surface to be protected. When a vehicle turns, the area of its tracks (their links and or links and pads) in contact with the ground must slide sideways across the ground in an arc centred about the vehicle's centre of rotation. The further any part of the track is from this centre, the greater the radius of its arc and the further that area of the track must slide during the turn. Sliding links or pads across hard surfaces causes them to abrade. Turning on softer or friable ground abrades them less, but instead causes a displacement of the surface (often soils and gravels) to the leading side-edge of the links and or pads as these are forced sideways through the surface materials. Where any but the briefest turn on soft or friable materials is made, these displaced materials build like a wave ahead of the advancing side of the link or pad and may spill backwards over that advancing edge into the path of the running wheels. Here, since links don't compress, the sharper gravels are forced into the tyres of the running wheels cutting and embedding themselves and reducing the tyre's life. Since tyres on tracked-vehicles usually comprise solid rubber (to avoid punctures) and are permanently bonded to the running wheels, the effective life of the whole wheel is governed by the operational life of its tyre. Sometimes during turns rocks are displaced or these very large waves of soil flood the tracks and completely bury the track horns. Here, the running wheels (particularly of sprung vehicles), may be forced upwards as they ride over the rock or soil and in doing so may become disengaged from the track horns. If the turn then still persists additional wheels become disengaged eventually allowing the track to misalign and potentially come off. Extended turns on soft grounds are avoided, where possible, for these reasons.

Sprockets are a consumable part designed to transfer motive power to the tracks. Most often this is achieved by teeth around the outside of the sprocket engaging with gaps designed into the track links to accept these teeth. As the sprocket revolves the track is drawn onto the sprocket. It then revolves around the sprocket until it disengages with the sprocket and travels off to perform its job elsewhere in the system. Since the power transferred from the sprocket is often large—the track itself must be sufficiently robust to utilise that power. Both the sprocket and the individual track links comprising the track are often, therefore, necessarily heavy. The teeth on a sprocket are subject to near continuous wear meaning sprockets need replacing regularly throughout the life of the vehicle. Since the sprockets engage directly with the tracks—the tracks must first be disengaged to replace the sprockets. This requires the track to be split (a track pin removed) before the sprockets can be unbolted. Removing track pins first requires the tension on the track to be released and, often, the links from which the pin is to be removed, to be supported. This is heavy work and, even with the right equipment, can often take several hours to achieve.

### SUMMARY OF INVENTION

The present inventive concept is directed to a track drive cassette for a vehicle, comprising a drive motor adapted to power a drive sprocket, a continuous track having a portion adapted to engage with the drive sprocket, running wheels, and a return arrangement.

Aspects of the present inventive concept enable tracked vehicles to be used in a wider range of circumstances. Thus, the present inventive concept provides for enhanced access capabilities for a vehicle. This is important in providing access to places which have previously been difficult or impossible to access.

The term “continuous track” includes a track formed by a plurality of individual track links.

The cassette may be adapted to be a discrete module removably attachable to a vehicle. It may be secured by fixings placed for ready access such that the attachable removal of the cassette is much simplified and can be completed rapidly. Such fixings may include bolts, commercially available quick-release anti-loose fasteners such as are often used to secure the drop-sides of a truck, or other means. Non-structural connections to the vehicle's main chassis such as fluidic pipes or electrical cables may be fitted with commercially available quick-release couplings, self-sealing quick release couplings, or socketed plugs as appropriate to aid the rapid disconnection of the cassette from the arms and or chassis.

A removably attachable cassette provides benefits over known arrangements because a removable cassette enables maintenance of the cassette to be undertaken away from the vehicle itself. Thus, a cassette can be removed and replaced allowing a vehicle to continue being used with a replacement while a removed cassette is maintained.

The cassette may be attached to a chassis of a vehicle by way of a support arm. Such a support arm may be substantially permanently fixed to the said vehicle and releasably attachable to the cassette. The cassette may comprise releasable attachment means suitable for the releasable attachment of a support arm to the cassette. Preferably the cassette comprises such releasable attachment means towards either end of the cassette.

A cassette may be attached to a chassis of a vehicle by way of two arms extending between the cassette and the chassis, the arms being arranged to form substantially a parallelogram with an edge of the cassette and an edge of the chassis being parallel to one another and the arms being parallel to one another. The arms may be pivotally attached to cassette. One or both arms may also be attached to a hydraulic ram. A ram can move the arm to which it is attached. Thus, the present inventive concept provides for a vehicle characterised in that the wheelbase width of the vehicle can be varied proactively in use.

The angles formed by the arms between the cassette and chassis whilst driving forwards, in use, can direct flexible items (such as saplings) under the path of the tracks rather than otherwise entangling the arms or chassis.

Preferably both arms are attached to a hydraulic ram. Preferably said both rams are operated simultaneously and in concert with one another to maintain a parallelogram formation. Alternatively, the arms could be attached to an actuator, hand crank or the like.

These arms may both be pivoted where they attach to the chassis, and similarly where they attach to the cassettes. One or both arms may also be attached to one or more hydraulic rams or actuators which are themselves pivoted at one end on the chassis and at their other end on the arms. Thus changing the length of a ram varies the angle between the arm and the chassis and so the lateral distance between the chassis and the cassette and so the vehicle's overall wheelbase width.

Increasing the vehicle's wheelbase width on a side-slope advantageously shifts the vehicle's lateral centre of gravity up-hill resulting in an increased stability when crossing side-slopes. This allows side-slopes to be navigated that are approximately twice as steep as existing vehicles can manage. It is envisaged that the present inventive concept could provide a vehicle capable of being used on a side slope of up to 57° to the horizontal.

For example, extending the cassette away from the vehicle chassis on the “down-hill” side of a vehicle and raising the suspension of that cassette to its maximum whilst retracting the “up-hill” cassette towards the vehicle chassis and lowering its suspension results in an advantageous shift in the vehicle's centre of gravity on slopes.

It is worth noting that the ability to vary the width of a vehicle's wheelbase is advantageous on its own, irrespective of whether proactive suspension is also provided or used. Proactively varying the wheelbase width of a vehicle is synergistic with proactively varying the height of the suspension of the vehicle. Thus, the combination of the two sets of features is highly advantageous over the prior art.

The present inventive concept also allows a vehicle to increase its wheelbase width providing greater stability when crossing ground at speed.

The ability to vary the vehicle's lateral wheelbase also offers benefits over known arrangements since it enables a vehicle's width to be minimised for simplified transport. A vehicle including the present attachment means may be configured to fit inside a standard shipping container when respective cassettes are arranged at a minimum width therebetween. Nonetheless, a vehicle of that configuration is not so limited in width in use due to the ability to extend the respective cassettes away from the vehicle chassis.

Extending one or both of the vehicle's cassettes increases the vehicle's lateral wheelbase; enhancing operational capabilities providing at least the following benefits for the user:

1) Extending both cassettes increases the vehicle's lateral wheelbase and thus its lateral stability when operating at higher speeds.

2) Extending one or both cassettes advantageously alters the vehicle's lateral C of G on side slopes enabling the vehicle to cross steeper side-slopes.

3) Extending the down-slope cassette and maximising its suspension height, whilst retracting the upslope cassette and minimising its suspension height advantageously optimises the vehicles lateral C of G enabling it to cross still steeper side slopes.

4) Retracting both cassettes and minimising their suspension height optimises the vehicle for shipping.

The cassette may further comprise means for receiving power from the main chassis. Such means may comprise a connector suitable for receiving a corresponding connector of a power supply. Power supplies envisaged include fluidic hose such as pneumatic or hydraulic hose and/or electrical cable. Preferably, the said connector may be disconnectable. Exemplary connectors include threaded sleeves and “quick release” type connectors.

Alternatively, the cassette may comprise a power generator, such as a releasably attachable auxiliary engine. A power generator may sometimes be referred to as a donkey engine. Thus, an unattached cassette module may be equipped with a donkey engine and a stabiliser (possibly a directable ski) allowing it to be moved and steered independently of the vehicle for servicing etc. or even as a prime-mover. Such a power generator is preferably attached to the cassette but may alternatively be attached via a bracket, stabiliser, or steerable stabiliser such as a ski.

A vehicle will generally have two track drive cassettes—arranged substantially in parallel to one another on either side of a main chassis of the vehicle.

The inventive concept enables the rapid exchange of one or both sides of the vehicle's entire track assembly. This may include the cassette's chassis, motor, sprockets, hydraulic, pneumatic, and electrical wiring, suspension-systems, controlling-electronics, track, return-roller assemblies, and track-tensioning system; thus reducing vehicle downtime and simplifying workshop operations.

The cassette may be provided with a plurality of running wheels. The running wheels are arranged to engage with the track at substantially a lower part of the track. The running wheels are generally arranged substantially in parallel with one another and substantially in parallel with the track.

The running wheels support the weight of the cassette and the vehicle more generally, in use. In turn a lower part of the track—which engages the ground in use—supports the weight of the running wheels.

Each running wheel may be attached to a discrete wheel station. In other words there is one running wheel only per wheel station. Each wheel station may be provided with a suspension arrangement to provide suspension to its respective running wheel. The suspension arrangement may comprise an idler and the suspension arrangement may be adapted to move the idler backwards or forwards to maintain track tension. As each wheel station is a separate unit, each suspension arrangement is substantially independent of other suspension arrangements of other wheel stations. Wheel stations within a cassette may be interchangeable so requiring fewer replacements to be stocked.

In previously-known track assemblies that have suspension the suspension swing arm supporting the wheels of the vehicle's undercarriage are each attached to a single common rail, i.e. a single beam with N swing arms (and their wheels). In contrast herein every swing arm is part of an independent wheel-station allowing damaged wheel-stations to be rapidly and readily removed and replaced. And, since each wheel-station is identical to the next, their positions can be easily interchanged (properly operating frontmost and rearmost swing-arms are more critical than centre ones in every tracked vehicle). All wheel stations herein may be fully self-contained including respective controlling means such as CAN based electronic controls, air/hydraulic/other piping, suspension means, swing-arms, etc. such that they are complete and ready to be fitted/removed as one piece.

A running wheel may comprise two discs arranged coaxially with one another, connected by an axle, with a discrete space between discs. Each disc may be paired back-to-back and may be attached to a discrete wheel station. In other words there may be one pair of discs, forming a running wheel, per wheel station.

A suitable suspension arrangement may comprise a swing arm having a wheel end which is in turn connected to a running wheel axle and a pivot end, the swing arm being pivotable about the pivot end to move the wheel end. The pivot end may in turn be connected to a suspension lever which may be moved by a suspension drive means.

Preferably the suspension drive means provides a force to substantially the drive end of the suspension lever, the drive end being at the end of the suspension lever away from the connection between the suspension lever and the swing arm.

The swing arm may be arranged to connect to the suspension lever at an angle. Preferably the angle is approximately 90 degrees. In such an arrangement, an approximately horizontal movement applied to the drive end of the drive lever results in an approximately vertical movement of the wheel end of the swing arm; vice versa, an approximately vertical movement of the wheel end results in an approximately horizontal movement of the drive end.

Alternatively or additionally the drive means may be resiliently extendable. Thus, the drive means may both move the wheel end approximately vertically and urge the wheel end to return to a position if displaced. Thus the suspension arrangement may provide both shock absorption and vertical displacement of the wheel end relative to the cassette.

The suspension drive means may comprise an air bag. An air bag can be inflated and deflated in a controlled manner to provide a desired shock absorbance and displacement for the drive end of the suspension lever. Alternatively, the drive means may comprise a pneumatic cylinder, a hydraulic cylinder or the like. A hydraulic cylinder may have an accumulator, such as a pressurised flexible bladder.

The suspension drive means may further comprise a lever adapted to create a mechanical disadvantage. This can improve the precision of height adjustment of the suspension and in turn provide for a smoother ride.

The return arrangement may comprise a plurality of return rollers arranged substantially parallel with one another and substantially in parallel with the track, at an upper part of the track.

Each wheel station may comprise one or more return rollers.

The or each return roller may be fixed in position with respect to its respective wheel station.

Movement of the swing arm may thus proactively increase or decrease a vertical displacement between a running wheel and the or each return roller, for a particular wheel station. Such a proactive increase or decrease in vertical displacement thus effects an increase or decrease in vertical displacement between respective portions of the track in the vicinity of the respective running wheel and return roller. The increase or decrease in vertical displacement is significantly more than in a classic suspension arrangement.

The cassette may further comprise an idler. The idler is located at substantially the opposite end of the cassette from the drive sprocket.

The idler may be substantially identical in form to the drive sprocket.

The idler may be powered. For example, the usual “trade off” between torque and speed can be accommodated by powering the idler.

The idler may be provided with braking means. Thus, the idler may provide independent braking from braking provided by the drive sprocket. Such independent braking of the idler may act as an emergency brake or other brake for the vehicle.

This increases vehicle safety by providing independent braking for the vehicle that is not dependant on the drive sprockets. This also simplifies component packaging allowing both drive and braking components to be separated for significantly faster repair. Alternatively, the idler may comprise a wheel which may be similar in form to a running wheel.

Preferably, the drive sprocket is located at substantially the “rear” end of the cassette with respect to the preferred direction of forward movement of the vehicle. Thus, when the vehicle is being driven in a forward direction, a track link will have a path which follows a loop passing under the running wheels, to the drive sprocket, over the return rollers, to the idler and back towards the running wheels. The skilled reader will appreciate that the drive sprocket alternatively may be located at substantially the “front” end.

The present inventive concept further provides a support arm arrangement for a return roller having a support arm and a sub-carrier, the support arm and sub-carrier being releasably connectable to each other, the sub-carrier being mounted on and projecting from the side of the cassette. The support arm can be rotated around the sub-carrier when in a released state, and rotationally fixed thereto in a fixed state.

Removing a support arm is then considerably simplified compared with known systems since the support arm can remain fully supported by the sub-carrier whilst fixings are removed. The support arm can be then simply rotated around the sub-carrier to disengage it fully from the weight of the track. The support arm can then be drawn axially away from the sub-carrier without requiring any physical support from a user, until the support arm is fully drawn away. The support arm and sub-carrier may each comprise corresponding axially engageable means, such as coaxial tubular elements.

Tracks are in general terms of fixed length and to avoid their separation (loss) from the vehicle during use it is desirable to maintain a track's permanent contact with all the components responsible for its guidance by keeping it suitably tensioned during use.

Varying the vertical displacement between running wheels and the return rollers (varying the vehicle's suspension height) will, all else being unchanged, vary the length of the track's guided path. Reducing the said displacement (compressing the suspension) will reduce the length of the guided path so slackening the track making it more likely to be shed. Increasing the said displacement increases the track's tension until the maximum track-tension the suspension system can apply is reached. The idler may be attached to the cassette by way of a linkage. A linkage allows the idler to be moved longitudinally in relation to the cassette whilst maintaining it in the plane thereof. Longitudinal movement of the idler may thus vary the length of the track's guided path and so vary or maintain the tension in the track for a given displacement.

Thus, the present inventive concept provides a continuous track for a vehicle, characterised in that the length of a guided path of the continuous track can be varied. Furthermore, track tension can be varied to adapt for changes in suspension height. More especially, track tension can be kept relatively stable during a change in suspension height. It is the combination of variable height suspension and the ability to apply the correct tension to the track throughout the range of suspension heights that enable these multiple benefits.

Many known tracked vehicles can alter their suspension height (usually from ‘ride-height’ to lower) but in lowering their height they necessarily slacken their tracks to the point the vehicles cannot be driven for fear of shedding their tracks. In the present system the track's tension is maintained by pushing forward or drawing back the idler using a powered means to either remove or supply slack into the track as required. Importantly, the present arrangement provides for a wide range of heights across which the tension may be maintained. The described tensioning device can move far farther than any other simple tensioning system to enable the track to change its entire geometry from (viewed in side-profile) the classic tank-track trapezium (at max height) right through to the rounded slot appearance of an excavator (lowest height and no suspension travel).

Many continuous track arrangements for vehicles have a means for correctly maintaining tension; the key advantage of the present inventive concept is that it enables a vehicle to actively reduce the height of its suspension at will, which would otherwise result in a slackness in the track that would be beyond the limited movement of other track tensioning mechanisms to correct. The vastly longer stroke present in this track tensioning arrangement, when coupled with the path of the arc in which this device maintains the movement of the idler and that the suspension on the vehicle can be lowered at will, combine to enable the vehicle to place (in the case of the present inventive concept's arrangement) 31% more of its tracks—flat on the ground—whilst still maintaining the correct track tension.

Ideally, the idler is moved in response to a proactive variation in the vertical displacement between running wheels and return rollers, as described above; with the aim of optimally re-tensioning the track in response to this variation

The linkage may comprise a piston. The linkage may comprise a cam.

The linkage may comprise a piston attached to a cam which is in turn connected to an axle for the idler. An extension or retraction of the piston will rotate the cam to move the axle. Thus, the linkage can extend well beyond the range of previous track-tensioning rams and enables the vehicle to maintain its correct track tension whilst varying its suspension height, altering its ground pressure, varying its traction, and increasing its trench-crossing capabilities etc.

The piston is preferably pneumatic. A pneumatic piston could provide an almost instantaneous adjustment to track tension. Alternatively an airbag, hydraulic ram or electric actuator could be used.

The idler may be positioned by way of a hydraulic ram. Thus, the idler may be effectively locked in a desired position.

In use, if the suspension is to be proactively raised (for example), the position of the idler may be allowed to vary by releasing pressure in the hydraulic lines that lock the idler. This allows the suspension to extend and raise the vehicle. At that time reduced hydraulic pressure behind the piston allows the piston to be retracted so the track tension is maintained.

By correctly calculating the position of the idler and its respective pitch circle diameter (“PCD”), the effective rolling radius of the idler and matching this with the diameter of the running wheels and other relevant factors, the idler can be made to rest on the ground with the base of its PCD horizontally substantially in line with the bottom of the running wheels as the suspension is proactively lowered—by the wheel stations, for example. This ability is engendered by the ability to extend the drive sprocket through an arc that allows the maintenance of the track tension whilst the vehicle suspension height is reduced (by the wheel stations). Once the above PCD is set the arc followed by the drive sprocket is the key to enable both the drive sprocket and the idler and all the running wheels to achieve a shared horizontal plane at their bases. Since tracks don't stretch this arrangement reconfigures the track's geometry such that ride height is exchanged for additional track-area in contact with the ground—which in turn reduces the vehicle's effective ground-pressure.

By lowering the vehicle's suspension height whilst maintaining the correct track tension by means of forcing the front idler or sprocket forward to take up the resultant slack in the track, it is possible for the operator to place an increasing length, and so area, of track on the ground, on demand, whilst the vehicle remains operational. This then: extends the vehicle's longitudinal wheelbase; places a greater area of track in contact with the ground; reduces the vehicle's height and so its centre of gravity, and allows differing ride-heights to be set for each side of the vehicle. These abilities improve the vehicle's operational capabilities providing at least the following benefits for the user:

1) Placing a greater area of track on the ground spreads the vehicle's weight over a larger area so reducing its ground-pressure allowing the vehicle to traverse still softer ground so extending its operational capabilities. Examples of user-advantages for this innovation include:

a. A vehicle bogged whilst at a higher suspension setting can reduce its ground-pressure to escape. Similarly, reducing the vehicle's ground-pressure enables it to cross still softer terrains.

b. Allows users to lay a greater area of track on the ground to increase traction.

2) Increasing, on demand, the vehicle's longitudinal wheelbase:

a. Improves its longitudinal stability enabling it to traverse greater longitudinal gradients.

b. Increasing its wheelbase also lowers the vehicle's suspension and thus its centre of gravity, further increasing the longitudinal gradients the vehicle can navigate.

c. Extends its trench-crossing abilities.

d. Reduces the vehicle's loading height.

To form a complete track a link must connect with another substantially identical link at substantially either end thereof. In other words, in terms of the track as a whole, each link will be attached to a further leading link and a further trailing link. Once the correct length of track is attained the unattached leading and trailing edges of the first and last links are joined to form the complete track.

A track link may comprise a pair of holes formed substantially at either end thereof, one of each pair being formed towards a leading end of the track link and the other of each pair being formed towards a trailing end of the track link, the pairs of holes being adapted to receive corresponding track pins. Adjacent links may pivot to a limited extent with respect to one another in the plane in which the track pin enables such pivoting around the pin. In the case of a continuous track drive arrangement, pivoting is desired in the plane in which the track is intended to move and pivoting is not desired in any other plane. In other words, pivoting allows the track links to move around sprockets and wheels, but not in other planes.

Clamps, bearings, seals, cover plates, etc., may be replaced, as may pins where necessary, to facilitate track refurbishment so reducing the vehicle's cost of lifetime ownership by extending the effective lifetime of the components comprising the tracks.

Links may be asymmetric yet, since their leading and trailing edges may be substantially identical, they may be adjacently mounted such that the hollows in their horns may be placed alternately along the length of the completed track to avoid biased wear from or to interacting components.

Preferably, track pins are clamped externally—i.e. at either end of the track link—using track clamps. Preferably, the track pins comprise replaceable bearings and seals.

The bearings may comprise pass through bearings having “O” rings at either end of bearing housings. The pass through bearings may be of nylon. The “O” rings may be of rubber. The “O” rings may further comprise an outer shim, preferably of steel. Preferably, an outer plate, preferably of metal, is provided. The outer shim and outer plate are intended to protect the “O” rings which protect the bearings. “O” rings can prevent grit etc. reaching the bearings and both “O” rings and bearings would be renewed during track refurbishment. Preferably, two “O” rings are provided.

The provision of track clamps reduces the overall complexity of the track link arrangement by not requiring interlocking link castellation, making the present construction simpler to manufacture via machining, for example.

The presently disclosed tracks are designed to offer a longer design life than either of the above known tracks—and, once worn, are designed to be refurbished to new standards at a minimal cost. Existing tracks are, as mentioned, not suitable for refurbishment and so the whole track tends to be fully discarded once a part thereof is worn. In contrast the present tracks, for example, use track pins that are clamped externally (at either end of) from the track link using track clamps.

In this arrangement, the track clamp is the only part of the track that contacts the drive sprocket and idler. Thus, the clamps are the only parts of the track which wear following mechanical contact with the drive sprocket, and idler if it is of the relevant form, rather than the links themselves. Thus, a track of this form can generally be maintained in good condition by replacing the clamps (only) when required. Other components of this track can also be replaced or repaired as required.

The inventive concept enables refurbishment of track links.

A track link may further comprise a track pad, generally disposed on the part of the link which will engage with the ground, in use. A track pad may be formed of a sacrificial resilient material, such as rubber.

The track pad is preferably detachably attached to the track link; allowing its replacement once worn. Pads may preferably be attached to the track link at two points. Point-loading on the pad and the opportunity to be torn free of its fixings may be reduced by spreading that loading across a plate between these fixings which further clamp the pad to its link. This two point fixing and plate differs from prior art since that commonly bonds the pad directly to the link, or bonds the pad to a metal plate which attaches to the link via a single retained bolt welded to the plate which then bolts through the link. Once the bonding fails in use the pad is released and usually lost, or should the single welded fixing fail then the pad and its metal plate are similarly ejected from the track and since these are often heavy—such without-warning ejection may be potentially hazardous. The design described here simplifies manufacture of the pad (since it requires no welding or bonding), and the pad is more readily retained since both fixings must fail for the pad to be released. Regular maintenance allows the replacement of any individually failed fixing and the pad and its plate remain attached to the track rather than being otherwise lost.

Furthermore, the track pad's manufacture uses no bonding process. This allows the track pad to be more simply manufactured and so the track to be fully refurbished at a lower cost. No bonding ensures no ‘bonding-failures’. The described design of the track pad and the described interaction and construction of the track pad, its track link, and the method of fixing the track pad to the track link mean that the track pad can be formed by a single manufacturing process such as moulding, rather than the multiple processes required for previous track pads. Enabling production by a single step manufacturing process reduces production costs.

It is a feature of tracks that those links in contact with the ground remain largely stationary as the vehicle's running-wheels pass over them but that they must then be accelerated to twice the speed of the vehicle on their return path. This generates significant centrifugal forces which this design utilises to expel aggregates trapped between the faces of adjoining pads. The geometry of the pins, links, and pads ensures that when a link travels around a wheel or sprocket, the seal between adjacent pads is opened. This occurs at the precise time of the link's acceleration or deceleration as it follows its prescribed path. Similarly, the cavity beneath the pads may self-empty through this same process.

This design also allows functional inserts to be mounted within the cavity beneath the pad simply by replacing the retaining plate. Such inserts may be used for a wide variety of purposes such as providing removably attachable ice-studs to the pads; adding a further layer of resilient material to the bottom of the pad for additional surface protection; or adding teeth to the bottom of the pad to enhance the vehicle's ability to gain a purchase on and so cross fallen trees (tsunami beach barriers or hurricane debris for example).

A track pad is preferably adapted to fit tightly into a void of a track link. A track pad may be attached to a track link by a nut and bolt connection. The track pad is preferably detachably attached to the track link, allowing its replacement once worn.

A track pad is preferably wider than the track link. A track pad may have a chamfered face to its underside. A chamfered face allows a pad to sledge over friable surfaces when the vehicle turns to reduce the volume of spoil entering the path of the road-wheels and so extending their operational life. A track pad may have a void or spoil chamber formed within the chamfered face. Whilst the vehicle is turning gravel (soil etc.) building within the void increases pressure between the ground and the area of pad forming the void causing the pad to flex away from the pressure and so increase the angle the leading tip of the pad presents to the spoil so ensuring the pad sledges over the spoil rather than its spilling over the pad and entering the path of the road-wheels. This increases the life of the road wheels and assists the track to ‘float’ over the spoil.

The pads of the present inventive concept offer several functions: to provide a cushioning barrier protecting road surfaces etc. from damage by the track links; to increase the area of the track's footprint (due to their width); to reduce the ingress of damaging spoil into the path of the running wheels; and to allow the fitment of specialist inserts to the track (fitted within these pads) to better enable the vehicle to cope with user-specific ground conditions. Inserts might include snow spikes, water paddles, etc.

Such a track pad design helps to exclude gravels from the path of the running wheels extending running wheel tyre life.

Adjacent track pads may be arranged so that front and leading edges of pads meet and compress against each other at the point the pads are being laid on the ground in use. This forms a seal along the length of the track that prevents the ingress of particles otherwise damaging to the track. This seal reopens as the pad rounds a sprocket allowing the centrifugal motion of the track at these points to eject particles otherwise stuck between these seals.

A track pad may be manufactured using a single process, such as formed from a rubber compound and conventionally moulded in the standard single stage process.

Each track link preferably comprises a track horn.

Preferably, a track horn has an approximately triangular profile. Such a profile enables a more effective engagement between a track horn and a running wheel of the cassette. Improved engagement between track horns and running wheels reduces the risk of the wheels “stepping out” of the track in use. Thus, a wider range of manoeuvres is available to a vehicle equipped with cassettes of the present inventive concept.

The track horns are generally designed to fit within the space between two paired discs forming a running wheel as described above. The track horns must have a height of no more than the available distance between the outer edge of the wheel and the axle thereof. It is important that the track horn is sized to maximise its size within the available space.

The track horns are preferably substantially as long at their base as the track link on which they are formed. This means that some part of each running wheel travelling over any track link is substantially fully aligned with the guidance provided by that link's track horn. This aims to ensure that some part of each running wheel travelling over any track link is substantially aligned with the guidance provided by the track horn, so minimising the opportunity for track loss through mutual misalignment. It also provides that rocks etc. from the ground are more likely to be expelled (squeezed out from between the track horns) rather than held more firmly in place as the track moves onto the sprocket—at which point tops and the sloping leading and trailing edges of the adjacent track-horns converge. This is in contrast to the prior art in which the leading and trailing edges of a link's horn often present vertical leading and trailing edges from their bases to their tops so, when transitioning to their curved phase, close like pincers to hold a rock, whereas in the present design the rock is forced out from an ever decreasing wedge. As each track link approaches the sprocket it transitions from a horizontal alignment with its attached neighbour, to curve around the sprocket. This action moves the foremost and rearmost edge of every adjoining track horn in a pincer movement from their pivot points to their tips. Rocks or other hard debris caught between the diminishing gap of these surfaces is squeezed out from between them due to their triangular shape. Other tracks lacking these shaped track-horns tend to grab the item (perhaps a rock) and retain it such that it is carried into the sprocket so potentially forcing off the track.

Sprockets may be provided with a guide therebetween. Such a guide may sit inside the two halves of each sprocket to centralise the track horns to ensure each track link's correct engagement with the sprocket teeth to assist track retention. This guide may be comprised of a further pair of road-wheels fixed to and between the sprockets and on the same axle as the sprockets and so rotating with them to centralise the track horns between them. This is valuable in all instances but particularly on extreme side-slopes where misalignment of the tracks commonly causes them to become dismounted.

This convergence of triangles around the guide forms a deep, robust, nearly gap-free semi-circle of obstacle-free track-horns allowing them to be readily centralised between these guides set between the sprockets to ensure the track remains centred on the sprocket (like the string in a yo-yo). This ensures that it's the track's horns that resist side-loads (which is their main purpose within the track) when the vehicle operates across side-slopes, rather than the teeth of the sprockets themselves. This ensures the track is maintained in alignment with the sprocket even when travelling across far higher side-angles than current vehicles can attain.

A link's track-horns may be manufactured such that the leading and trailing faces they present to the advancing running wheel may be substantially identical, yet one side of the horn may be hollowed enabling a weight saving.

This track horn design combines with other discussed features to enable the vehicle to cross-side slopes greater than that of prior art. So equipped, a wider range of manoeuvres is available to a vehicle equipped with cassettes of the present inventive concept.

Where a running wheel has only a single disc, pairs of track horns may be provided so that the pair of track horns are arranged on either side of the disc.

The track horn may be hollowed on one side to save weight. From a front or rear elevation, in other words the perspective encountered by an oncoming running wheel in use, may be symmetrical—in other words the track horn is visually identical from front to back.

As the links are visually identical when viewed from the front or the back, the hollowed sides of the track horn are alternated during the track's construction such that each hollow falls alternatively to the left or right along the track's length. Since each track-link is so closely attached to the one ahead and behind it on the track—and since each link in the track must rotate about its pin to follow the curve of the sprockets, the track-horns necessarily become triangular (to enable this curve). It also means, however, that when they move from their horizontal phase to their rotated phase (as they move around the sprocket)—any debris laying between the track-horns of any two adjacent links is progressively squeezed out rather than held ever more tightly in place as with traditional track-horn design. Again, this assists in ensuring the alignment of the track as it passes onto the sprockets is maintained since track-alignment-disruptive debris such as rocks etc. are more readily expelled prior to engagement with the sprocket—rather than being crushed against the sprocket.

A sprocket may be formed of two or more separable sprocket components. This enables individual sections of sprocket to be replaced without removing the tracks. Preferably, each sprocket component is substantially a sector of a substantially circular sprocket. In other words, each sprocket component is “wedge” shaped. Sprocket components may be adapted to be releasably connectable to one another.

This arrangement enables sprocket components to be removed and replaced individually, without removing the whole sprocket from the cassette. This is advantageous because to remove a whole (previously known) sprocket from the cassette would require prior disengagement of the track from the sprocket. This would involve splitting the track by de-tensioning it, clamping two adjoining links together using bespoke tools, removing the track-pin retaining devices on one or more pins connecting the clamped links, and then withdrawing those pins using a bespoke pulling tool. The devices holding the two adjacent links in place must then be released in such a way as to avoid injury as the two freed ends of the track, if incautiously released, will fly violently apart under the weight of the released track. Thus, the presently disclosed arrangement allows for saving significant time and effort, so extending the vehicle's operational availability whilst enhancing the safety of its maintenance.

More than one sprocket component can be removed and replaced by removing and replacing one sprocket component, then rotating the sprocket to give access to another sprocket component. In general, a sprocket component will be accessible for removal and replacement when that sprocket component is not in engaged with a portion of the track.

Sprocket components may be releasably connectable to a sprocket rim. A suitable releasable connecting means may be rods, dowels, bolts, threaded bolts and the like.

A sprocket may comprise a sprocket rim into which sprocket components may be removably attached, for example by bolts. A sprocket component may comprise one or more teeth. Preferably, a sprocket component comprises three or four teeth.

Ideally a sprocket component forms up to approximately a third of the circumference of the sprocket. Thus, a single sprocket component can be removed from the sprocket without having to first remove the sprocket as a whole from other components.

The present inventive concept also provides a modular engine bay arrangement for a vehicle.

A vehicle's “power cube” provides a modular enclosure for the protection and support of the vehicle's means of power generation. The power cube may enclose a diesel engine connected directly to a pair of hydraulic pumps—although other means of indirect connection, i.e. via a clutch, may be used. Turned by the engine these pumps pressurise hydraulic fluid which is then forced through suitable pipes both rigid and flexible, as appropriate, to the motors so turning the sprockets currently placed at the rear of the vehicle's cassettes (though these could be placed at the front). This generates drive. Where these pipes enter/leave the power cube they can be bisected by commercially available and conveniently placed quick-release couplings. Similarly, all additional connections to the engine/pumps required for their operation can be fitted with suitable plugs/connectors etc. that allow quick attachment and disconnection. The power cube itself can be attached to a centre section of the vehicle by bolts that are individually accessed, one from each of corner of a front face of the power cube. The power cube can be additionally supported by rails fitted to its two top longitudinal edges. These rails can be on rollers enabling this inner rail to move freely within an outer rail that projects forwards from the vehicle's centre section. Once all couplings are released and the retaining bolts removed, the power cube can then be suitably supported whilst slid forward on these rails until it is suitably distant from the centre section that it can be detached from the rail to sit on the floor ready to be exchanged.

The power cube could additionally/alternatively contain batteries to drive electric motors on the cassettes, or a differing power source and generator combination operating either directly or through batteries, or any other power source or combination suitable to power the vehicle.

Often an exchange of the power cube and its power source from the vehicle will be due to malfunction. However, due to the rapidity and simplicity of exchange it is probable that this may also be undertaken simply for convenient servicing. To facilitate this the essential pipes/cables/tubes connecting it to the centre section may be provided of sufficient length that the power cube may still power the vehicle from its disengaged location (i.e. pulled forward off its supporting rails and so essentially sitting on the floor—but whilst still connected to the vehicle by its cables and pipes etc. Here, the vehicle may still remain mobile (within the range of these cables/pipes) and so, using the vehicle's adjustable suspension height and its ability to manoeuvre, this would allow the vehicle's operator to exchange a power cube as required, that is, exchange a power cube without the need for additional lifting gear/jacks etc. Similarly, any power cube positioned in cable/tube etc. reach of the centre section can be similarly reattached.

### DETAILED DESCRIPTION OF THE INVENTION

Examples of certain aspects of the present inventive concept will now be described with reference to the accompanying drawings, in which:

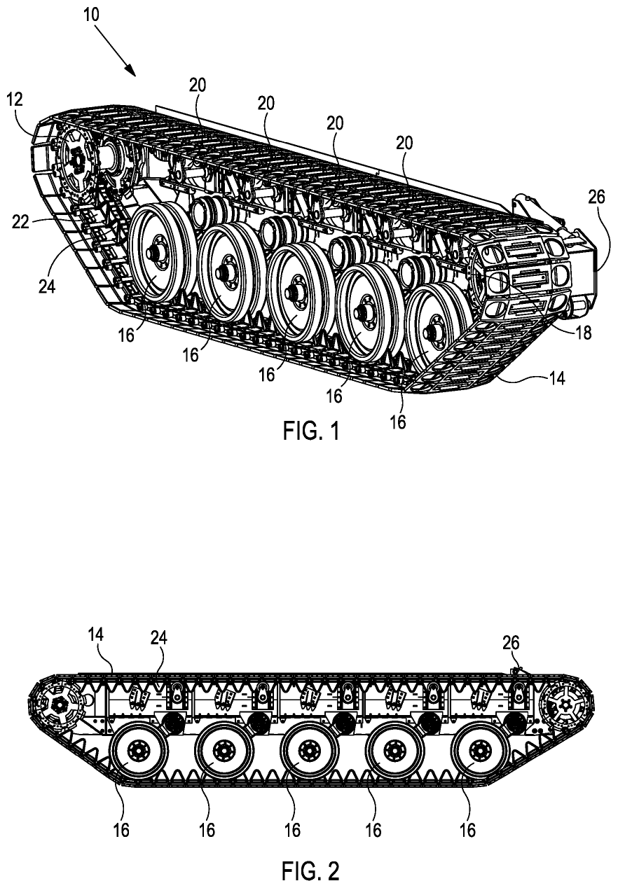

FIG. 1 shows a perspective view of a track drive cassette for a vehicle;

FIG. 2 shows a side view of a track drive cassette for a vehicle;

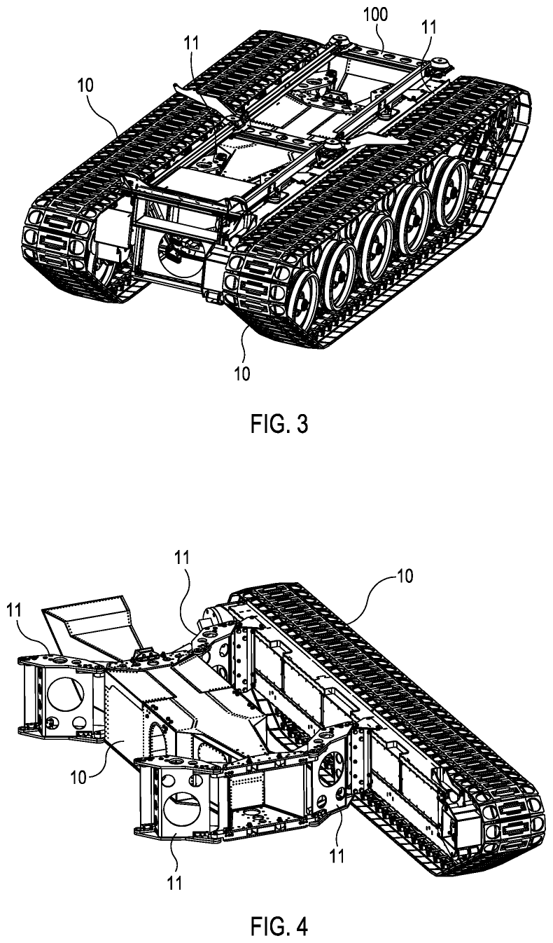

FIG. 3 shows a perspective view of an arrangement of two cassettes connected to a chassis;

FIG. 4 shows a perspective view of a single cassette and means for connecting it to a chassis;

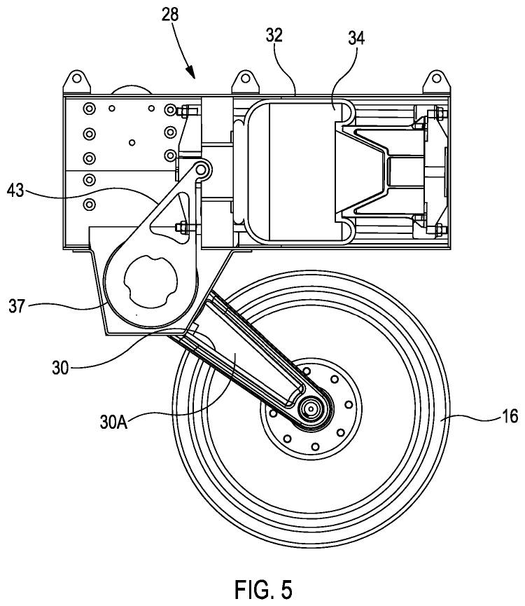

FIG. 5 shows a section through a wheel station;

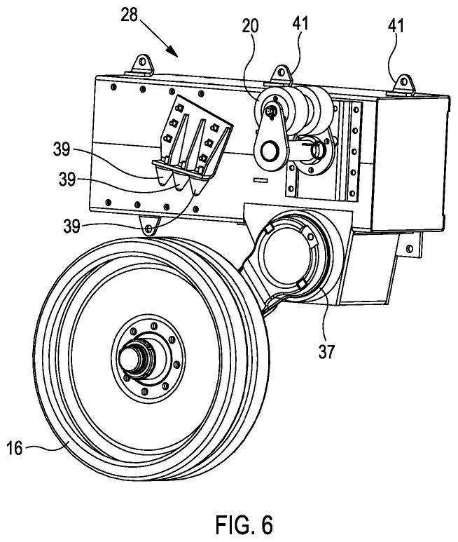

FIG. 6 shows a perspective view of the wheel station of FIG. 5;

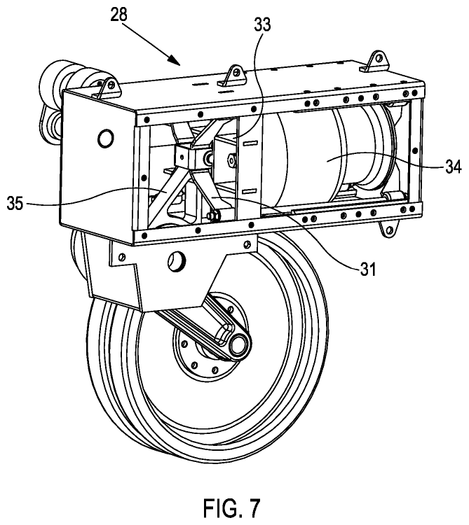

FIG. 7 shows a further perspective view of the wheel station of FIG. 5 showing some internal components;

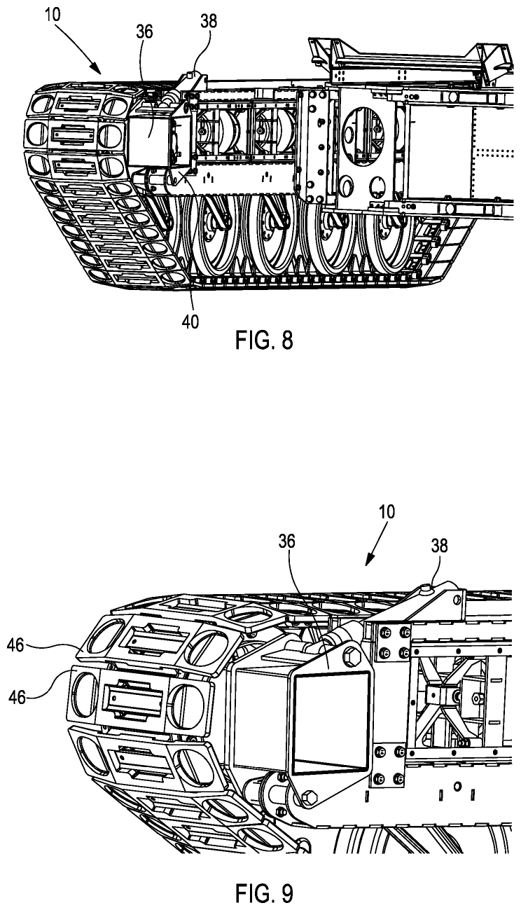

FIGS. 8 and 9 show perspective views of parts of an adjustment linkage arrangement;

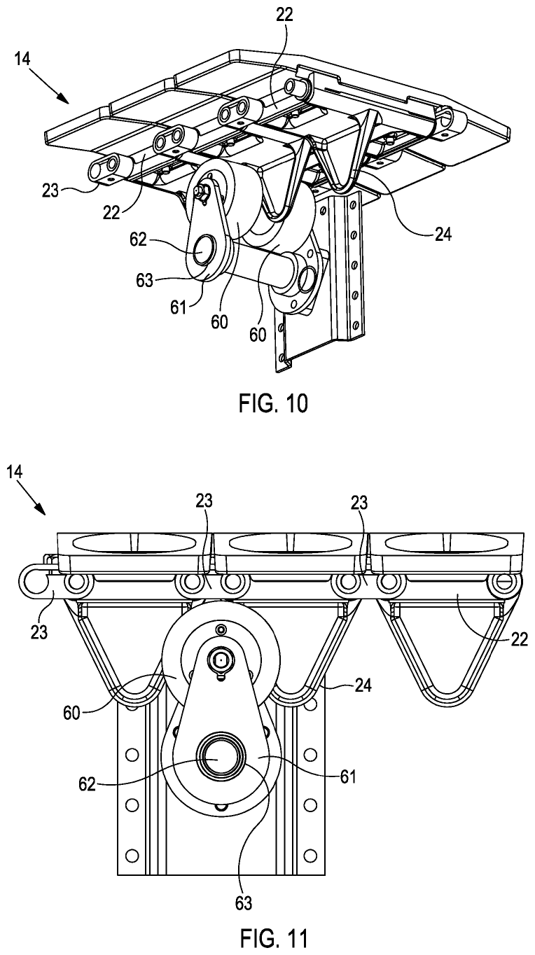

FIG. 10 shows a perspective view of parts of a track, track links and a return roller;

FIG. 11 shows a side view of parts of a track, track links and a return roller;

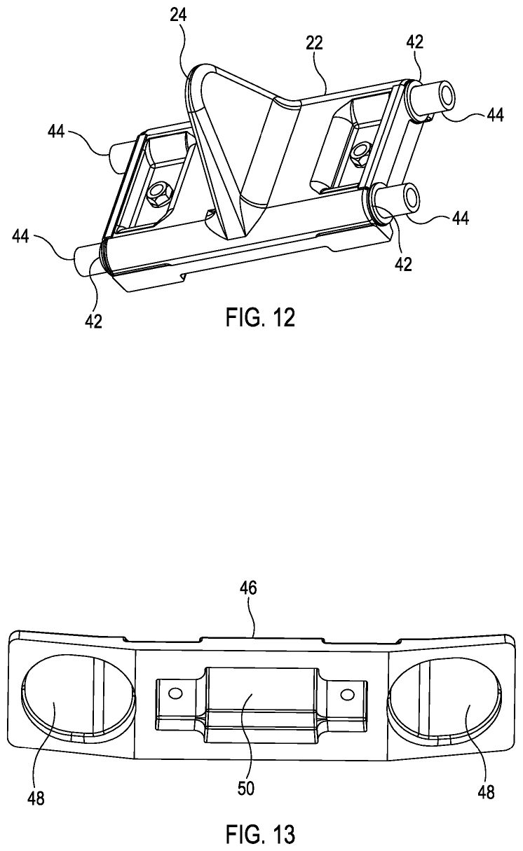

FIG. 12 shows parts of a track link;

FIG. 13 shows a track pad;

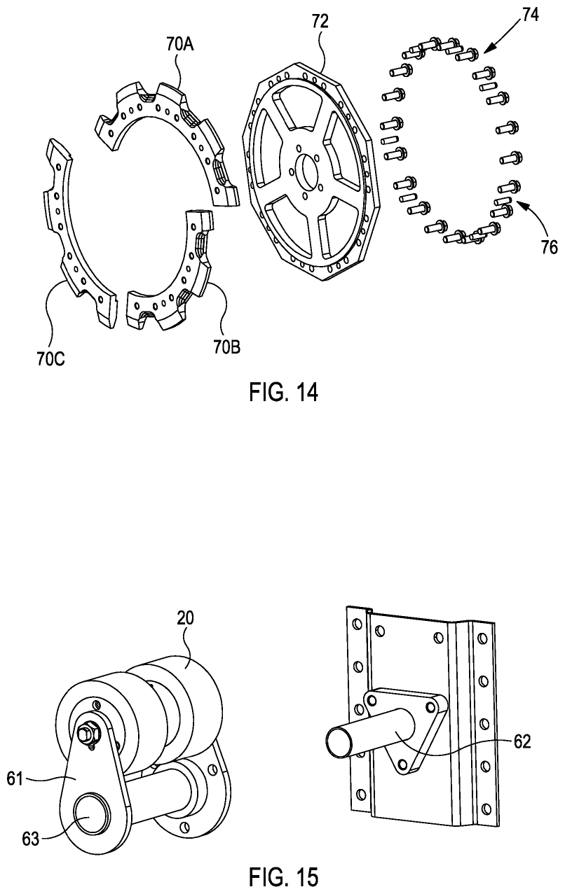

FIG. 14 shows an exploded view of a sprocket;

FIG. 15 shows an exploded view of a support arm arrangement;

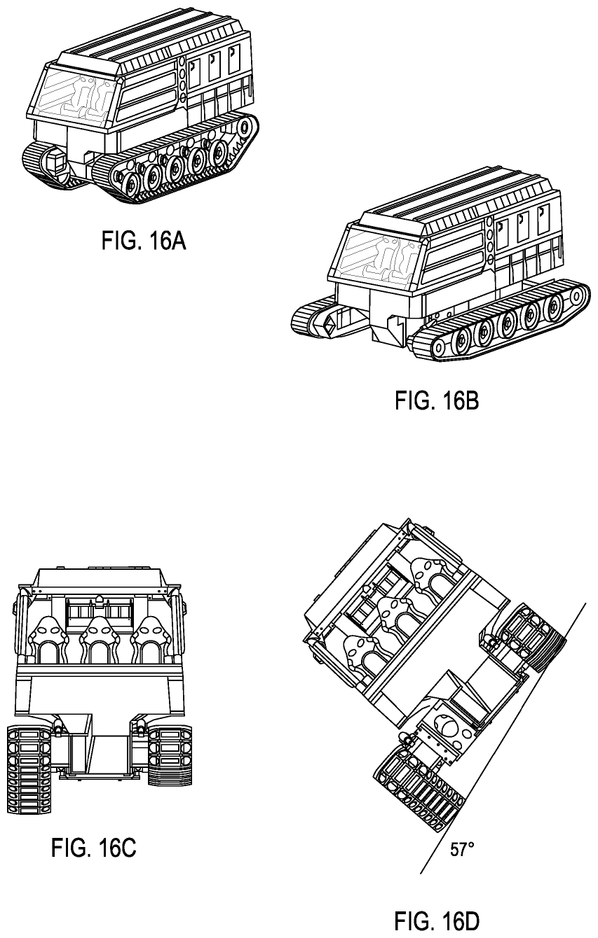

FIGS. 16A, 16B, 16C, 16D shows a vehicle with exemplary cassettes in different states;

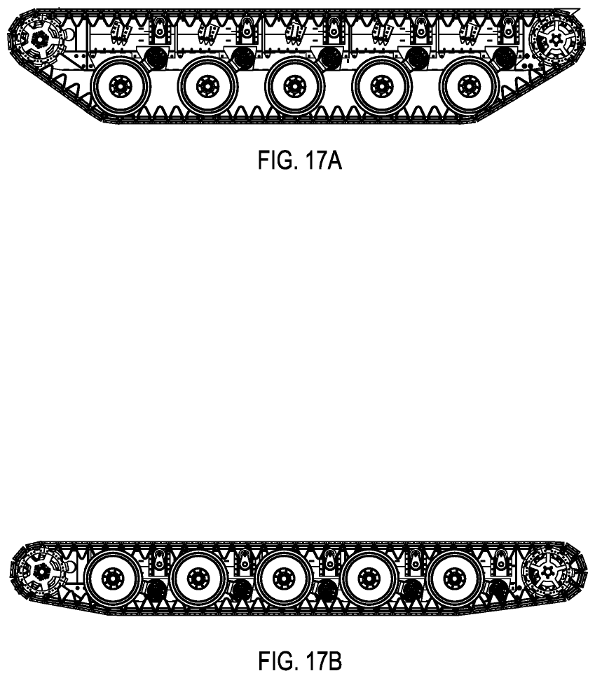

FIGS. 17A, 17B shows a cassette in different states

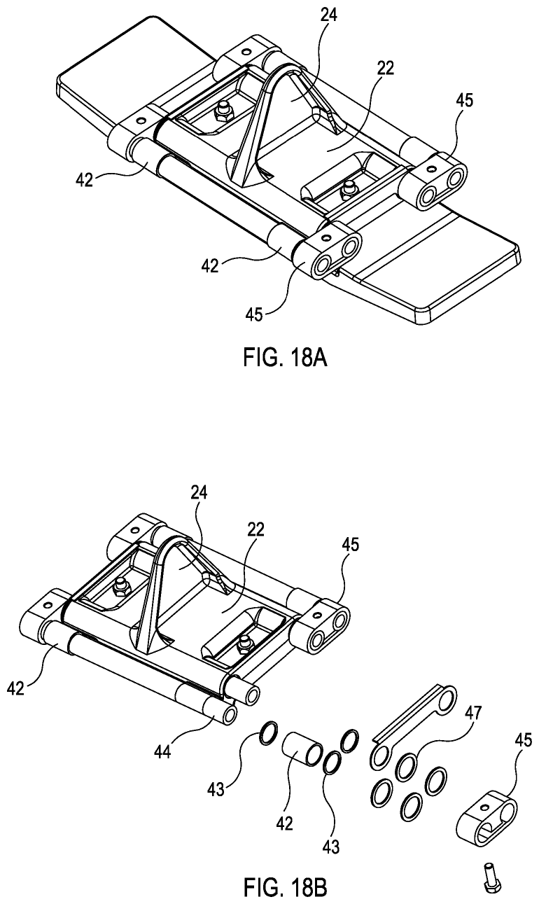

FIG. 18A shows a track link, and FIG. 18B shows the same track link in a partially exploded view;

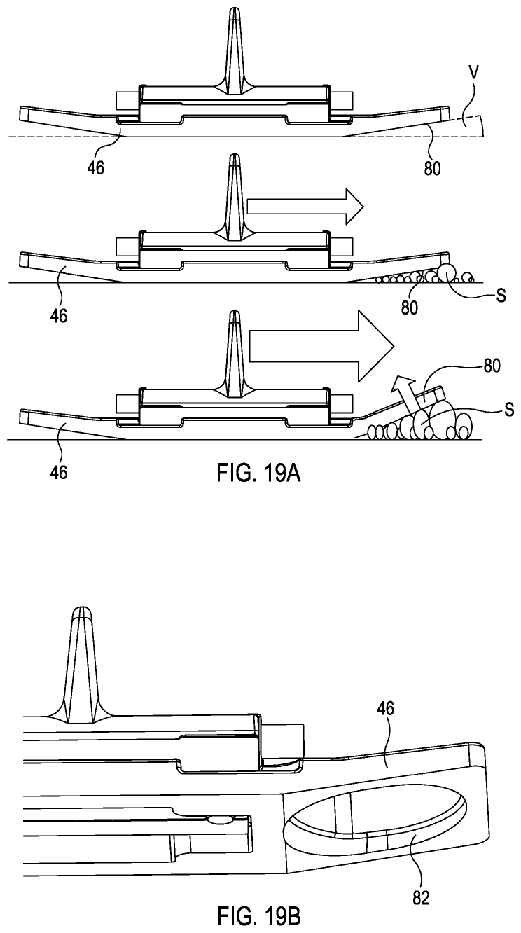

FIGS. 19A, 19B show a track pad in various states when interacting with spoil on a surface to be traversed; and

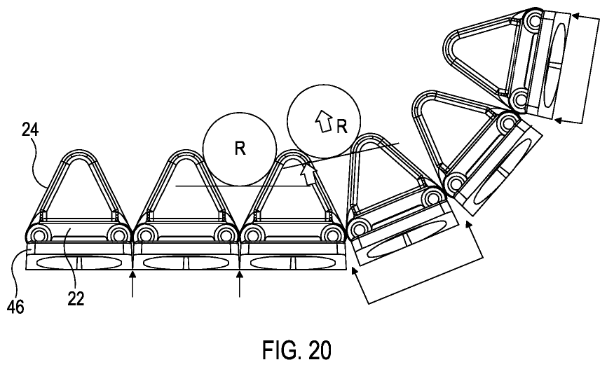

FIG. 20 shows how debris can be removed from the track by its arrangement during operation.

Certain elements of the inventive concept are shown in certain drawings without being labelled explicitly, to aid clarity.

Turning to FIGS. 1 and 2, a track drive cassette 10 for a vehicle has a drive sprocket 12 which engages with a continuous track 14. The drive sprocket 12 is adapted to be powered by a drive motor (not shown), the continuous track 14 having a portion adapted to engage with the drive sprocket 12. The cassette 10 further comprises running wheels 16, idler 18 and return rollers 20. The cassette 10 is adapted to be a discrete module removably attachable to a vehicle. The track 14 comprises a series of track links 22, the track links having track horns 24 attached thereto. The cassette 10 also has a linkage 26 connected to the idler 18.

FIG. 3 shows two cassettes 10 mounted either side of a chassis 100. Arms 11 (partially obscured in FIG. 3) connecting the cassettes 10 to the chassis 100 are fully closed minimising the vehicle's width for road use or transport. In this drawing the cassettes 10 are raised to their maximum suspension height—as may be used for travelling at speed. Each cassette 10 can be individually extended or retracted from the chassis 100 and suspension heights are similarly independently variable between cassettes 10. This enables significant advantageous shifts in the vehicle's overall centre of gravity allowing it access across side and longitudinal slopes impassable to other vehicles.

FIG. 4 shows the an individual releasably attachable cassette 10 attached by arms 11 on one side the chassis 100. On the other side of the chassis 100 from the cassette 10, arms 11 are shown without a cassette attached.

The cassette 10 comprises a series of wheel stations 28, an individual wheel station being shown in more detail in FIGS. 5, 6 and 7. Wheel station 28 provides a linkage 30, having a swing arm 30A, the linkage 30 being arranged between a running wheel 16 and a suspension arrangement 32. The suspension arrangement 32 has an air bag 34 connected to one end of a drive arm 43 of the linkage 30. The air bag 34, the drive arm 43 and the linkage 30 form a suspension drive means. The drive arm 43 and linkage 34 are joined by a detachable bearing arrangement 37. The air bag 34 provides resilience to the linkage 30. The suspension arrangement 32 can thus mitigate vertical movement of the running wheel 16. Furthermore, proactive extension or retraction of the air bag 34 (by inflation, for example) enables the vertical displacement of the running wheel 16 with respect to the rest of the wheel station 28 to be varied.

FIG. 6 further shows a return roller 20, as part of the wheel station 28. The linkage 30 has a swing arm with a pivot point 37. The return rollers 20 of the wheel station 28 are located directly above the bearing arrangement 37 of the swing arm. The return rollers 20 carry and guide the returning track. The wheel station also has three rubber bump stops 39 for the swing arm. The wheel station 28 has fixing points 41 are seen as lugs with holes and set in a plane around the other edges of the wheel station 28.

FIG. 7 shows the wheel station 28, in which an airbag 34 can extend and contract within a cage 31. The airbag 34 is anchored at one end against a reaction matrix 33 part way along the wheel station 28) through which the cage 31 passes to allow it to engage with the drive lever 35. As the airbag 34 expands it pushes the right hand end of the cage 31 further from the reaction matrix 33 whilst pulling its left hand end closer to the matrix. Since the left hand end of the cage 31 is attached to the drive lever 35, which in turn pivots around the linkage 30, the suspension height is raised as the airbag 34 expands.

FIGS. 8 and 9 show a portion of the cassette 10 from a different perspective, showing the linkage 26 which is connected to the idler (not shown in FIGS. 8 and 9). The linkage 18 has a cam 36 attached to a piston 38. The idler is attached to the cam 36 in such a configuration that when the piston 38 extends or retracts, in use, the cam 36 rotates about an axis 40 so that an axle of the idler moves with respect to the cassette 10. In FIG. 9 it can be seen that in the region of the idler, for example, track pads 46 separate to form gaps therebetween. Thus, any sealed relationship between track pads 46 is broken at that stage. This is likely also to occur when track links move into other rotational phases.

FIGS. 10 and 11 show portions of the track 14, the track 14 has track links 22, each of which has a track horn 24 attached thereto. The track horns 24 are sized and shaped to fit between discs 60 of the return roller 20 of the wheel station (not shown in full) and between discs of the running wheel (not shown). The track horns 24 are restricted by the discs, and thus track movement laterally is restricted by the track horns and discs. Track links 22 are attached to one another by track clamps 23.

FIGS. 10, 11 and 15 also show a support arm arrangement for the return roller 20 which has a support arm 61 and a sub-carrier formed by a tube 62 which is arranged coaxially within a tube 63 of the support arm 61, so that the tubes 62, 63 are releasably connectable to each other. The tube 62 of the sub-carrier is mounted on and projecting from the side of the cassette (not shown). The support arm 61 can thus be rotated around the sub-carrier 62 when in a released state, and rotationally fixed thereto in a fixed state. In use, removing a support arm 61 can be then simply rotated around the sub-carrier 62 to disengage the return roller fully from the weight of the track. The support arm 61 can then be drawn axially away from the sub-carrier 62 without requiring any physical support from a user, until the support arm 61 is fully drawn away.

FIG. 12 shows a track link 22 having bearings 42 engaging track pins 44. Bearings 42 enable the track links 22 and track pins 44 to be stripped, refurbished, and reused. This is useful because the track links and track pins are expensive to manufacture. Prior art arrangements generally require all components to be scrapped when some components are worn. Track links 22 can be attached to one another using clamps (not shown) which attach to track pins 44 of adjacent track links 22. The track link 22 has a track horn 24 projecting therefrom.

FIG. 13 shows a track pad 46. The track pad 46 has two gravel cavities 48, one at each side of the track pad 46. A central cavity 50 is designed to accommodate bespoke inserts. The track pad 46 may be chamfered on their underside side faces (in use) to assist them to sledge over the top of any spoil displaced by the vehicle when turning. This largely avoids the generation of any potentially damaging wave of spoil being generated during turns. Additionally, a cavity may be set into the underside of the pad's chamfered face which may trap a portion of any accumulating spoil. As a vehicle turn continues, spoil trapped by such a cavity becomes compressed as more spoil is forced into it. Since the track pad 46 may be manufactured from a semi-flexible material and with nowhere else to go, this additional pressure forces it upwards causing a further increase in the angle presented to the incoming spoil and enhancing its sledging effect.

The leading and trailing faces of adjacent pads may be designed to be slightly oversized for the space they should occupy in relation to the length of track they need to cover. Consequently their leading and trailing edges become compressed by one another when laid horizontally on the ground during use. This produces a compressive seal between adjoining pads that resists the ingress of aggregates whilst presenting the faces of the track pads in contact with the ground as an effectively unbroken surface ensuring maximum possible contact area.

Such a seal may also assist the prevention of aggregates reaching the track's bearing seals so extending their lives. Where aggregates do penetrate the seal between adjacent pads they are encouraged to be ejected in use as this seal is reopened as the link moves from its horizontal plane of contact with the ground—to the longer curved path around the sprocket or idler.

FIG. 14 shows an exploded view of a sprocket 70 which comprises three sprocket components 70A, 70B, 70C each having teeth for engagement with the track of the cassette as described (not shown). The sprocket 70 is connected for use with a sprocket rim 72 by a plurality of threaded bolts 74 and dowels 76. The bolt connection between the sprocket components 70A, 70B, 70C and the sprocket rim 72 enable individual sprocket components to be removed for maintenance and/or replacement without the whole sprocket requiring removal. Thus in use the track need not be dismantled in order to maintain and/or replace sprocket components 70A, 70B, 70C.

FIG. 15 shows an exemplary view of a support arm arrangement.

FIG. 16A shows a vehicle having two cassettes, with both cassettes being set in a raised state. FIG. 16B shows the same vehicle with both cassettes being in a mostly lowered state. FIG. 16C shows the same vehicle with one cassette (on the left-hand side) being in a raised state and the other cassette (on the right-hand side) being in a lowered state. In the state shown in FIG. 16C the vehicle is arranged to traverse an angled surface while maintaining the cab of the vehicle substantially horizontally. FIG. 16D shows the same vehicle with one cassette (on the left-hand side) being in a raised state and extended away from the vehicle and the other cassette (on the right-hand side) being in a lowered state and drawn into the vehicle. In the state shown in FIG. 16D the vehicle is arranged to traverse a maximally angled side-slope.

FIG. 17A shows a cassette in a raised state. FIG. 17B shows a cassette in a mostly lowered state. Track tension is maintained in different states and during transition between states as described herein.

FIGS. 18A and 18B show a track link 22. Certain features are not labelled to aid clarity. The track link 22 has bearings 42 engaging track pins 44. The bearings 42 have “O” rings 43 and washers 47 (only one of each labelled to aid clarity) arranged between the track link 22 and a track link clamp 45. The bearings 42, “O” rings 43, washers 47 and track link clamps 45 may be replaced, enabling the track link 22 to be reused after repair or rejuvenation. The track link 22 has a track horn 24 projecting therefrom. The track horn 24 is formed with a hollow or indented side. A hollow sided track horn 24 presents the same front and rear profile to the road wheels but saves weight by using fewer materials so reducing costs, and improving fuel economy. The hollow sides also provide an open volume for spoil to be temporarily accommodated so keeping the mechanism's operation smooth should it enter.

In FIG. 19A, a track pad 46 is shown with a chamfered edge 80. In the first state, a void V forms under the chamfered edge 80. In the second state as the track pad 46 slides sideways during a turn it sledges over gravel and other spoil S, which builds up under the chamfered edge 80 and is accommodated by the space under the chamfered edge. A chamber 82 or recess (shown in FIG. 19B) is formed in the underside of the track pad 46. The chamber 82 forces the spoil S to accumulate. This increases the pressure within the chamber 82 and beneath the chamfered edge 80 of the track pad 46 so lifting it and providing or augmenting a “sledging” effect. As seen in the third stage, repeated or prolonged turns cause spoil S to accumulate within the chamber 82 forcing the chamber upwards and so increasing the sledging.

In FIG. 20, a series of track links 22 are shown (not all labelled to aid clarity). As track links 22 move from horizontal to rotate around the sprocket (not shown) the gap between the triangular track horns 24 (not all labelled to aid clarity) narrow encouraging hard debris such as rocks R to be squeezed out and ejected before engagement with the sprocket. Tracks pads 46 (not all labelled to aid clarity) are longer than the track links 22 and when aligned with each other, as shown, they are pressed together forming a seal that resists water and grit so protecting the track links 22. As track pads 46 rotate around the sprocket they leave horizontal alignment so re-opening the seals and ejecting any accumulated debris.

1. A track drive cassette for a vehicle, comprising a drive motor adapted to power a drive sprocket, a continuous track having a portion adapted to engage with the drive sprocket, running wheels, and a return arrangement.

2. A cassette according to claim 1, adapted to be a discrete module removably attachable to a vehicle.

3. A cassette according to claim 2, wherein the cassette is attached to a chassis of a vehicle by way of a support arm, or wherein the cassette is attached to a chassis of a vehicle by way of two arms extending between the cassette and the chassis, the arms being arranged to form substantially a parallelogram with an edge of the cassette and an edge of the chassis being parallel to one another and the arms being parallel to one another, and wherein one or both arms is attached to a hydraulic ram.

4. A cassette according to claim 3, wherein the support arm is substantially permanently fixed to the said vehicle and releasably attachable to the cassette.

5. (canceled)

6. (canceled)

7. A cassette according to claim 2, further comprising means for receiving power from the main chassis.

8. A cassette according claim 1, comprising one or more running wheels each attached to a discrete wheel station, wherein each wheel station is provided with a suspension arrangement, each suspension arrangement being substantially independent of other suspension arrangements of other wheel stations.

9. (canceled)

10. A cassette according to claim 8, wherein the suspension arrangement comprises an idler and the suspension arrangement is adapted to move the idler backwards or forwards to maintain track tension, or wherein the suspension arrangement comprises a swing arm having a wheel end which is in turn connected to a running wheel axle and a pivot end, the swing arm being pivotable about the pivot end to move the wheel end.

11. (canceled)

12. A cassette according to claim 8, wherein the suspension arrangement further comprises a suspension drive means.

13. A cassette according to claim 12, wherein the suspension drive means further comprises a lever adapted to create a mechanical disadvantage.

14. A cassette according to claim 12, wherein the suspension drive is moved by an air bag, pneumatic cylinder, hydraulic cylinder, electric actuator.

15. A cassette according to claim 1, comprising an idler substantially identical in form to the drive sprocket.

16. A cassette according to claim 15, wherein the idler is attached to the cassette by way of a linkage comprising a piston attached to a cam which is in turn connected to an axle for the idler.

17. (canceled)

18. A cassette according to claim 1, characterised in that the length of a guided path of the continuous track can be varied.

19. A cassette according to claim 1, comprising track links having a track horn which has an approximately triangular profile, and wherein the track horn is as long at its base as the track link on which it is formed and wherein the track horn is hollowed on one side.

20. (canceled)

21. (canceled)

22. A cassette according to claim 1, having a sprocket formed of two or more separable sprocket components.

23. A cassette according to claim 1, wherein sprockets are provided with a guide therebetween.

24. A cassette according to claim 1, further comprising one or more of a power generator; an idler provided with braking means; a support arm arrangement for a return roller having a support arm and a sub-carrier releasably connectable to each other, the support arm being rotatable about the sub-carrier in use; and a track link comprising a track pad generally disposed on the part of the link which will engage with the ground, in use.

25.-27. (canceled)

28. A cassette according to claim 24, wherein the track pad is detachably attached to the track link at two points, the track pad is wider than the track link, and the track pad has one or more chamfered underside faces.

29. (canceled)

30. (canceled)

31. A cassette according to claim 28 wherein the track pad has a void formed within the one or more chamfered faces.

32. A cassette according to claim 24, wherein adjacent track pads are arranged so that front and leading edges of pads meet and compress against each other at the point the pads are being laid on the ground in use.

33. A cassette according to claim 1, further comprising track pins, wherein the track pins comprise bearings.

34. A cassette according to claim 33, wherein the bearings comprise pass through bearings having “O” rings at either end of bearing housings.

35. A vehicle comprising at least one track drive cassette according to claim 1, the vehicle characterised in that the wheelbase width of the vehicle can be varied proactively in use.

36. (canceled)
